(19) United States
(12) Patent Application Publication
(10) Pub. No.: US 2005/0235001 A1
(43) Pub. Date: Oct. 20, 2005

(54) Method and apparatus for refreshing materialized views

(76) Inventors: Nitzan Peleg, Haifa (IL); Yuval Sherman, Haifa (IL)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/813,843

(22) Filed: Mar. 31, 2004

(51) Int. Cl. G06F 7/00

(52) U.S. Cl. 707/200

(57) ABSTRACT

The disclosed embodiments relate to an apparatus for performing refresh operations. The apparatus comprises a base table having a first set of data entries, a materialized view having a second set of data entries that are associated with the first set of data entries in the base table. Further, a refresh log contains a set of changes that were made to the base table since the materialized view was last refreshed. A module is utilized to perform a refresh operation on the materialized view using the second set of data entries. The module is configured to access the refresh log and the materialized view, calculate delta values from the set of changes in the refresh log and the second set of data entries, apply the delta values to second set of data entries in the materialized view, and provide the delta values to a delta adaptation module for updating a second materialized view.

### BACKGROUND OF THE RELATED ART

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

Modem computer databases may store immense amounts of data. This data is typically stored in one or more tables that comprise the database. If a database contains large amounts of data, it may take a relatively long time to perform a query to retrieve data of interest to a user. The time required for a database to respond to a query may have an adverse impact on the performance of the database as a whole. If the database is subject to a large number of complex queries, the response time for each query may be seriously lengthened. A query may identify a subset of elements of a table. The subset may be referred to as a “view.” If a view requires information from several tables or is frequently requested by users, the view may be created as a “materialized view” to improve the performance of the database. When a view is materialized, it may actually be stored as a separate table within the database. Queries may then be run against the materialized view without incurring processing time penalties for reassembling the information contained in the materialized view each time a query that may be satisfied by the materialized view is performed.

To make sure that the integrity of data provided by a database is maintained, the data stored in a materialized view may need to be updated when the underlying data in the base tables that affect the materialized view is changed. When changes to underlying base tables occur, the database engine or database management system (“DBMS”) may create and/or update a log showing the changes. Periodically, the DBMS may use the information contained in the log to update or refresh a materialized view through the use of a refresh application that may be a separate application from the DBMS.

In a complex database environment, the data from the base table is moved from the database to the refresh application, and the updated data is moved back from the application to the database. When the amount of data in the base table is large, the movement of the data outside the database and back again along with the associated overhead of multiple database application programming interface (API) calls, which involve inter-process communication, is a very time consuming operation. This may reduce the availability of the system because the materialized view may not be available to provide data in response to queries when the materialized view is being updated by the refresh application.

In addition, with multiple materialized views, a refresh application may have to individually update each of the materialized views, even though the materialized views may be stacked over each other. The materialized views may be stacked when one materialized view is derived from the data in another materialized view. For each refresh operation, the movement of the data and the associated overhead with API calls is increased because of the different materialized views are individually updated. These materialized views may be unable to pipeline the refresh operations of several materialized views to avoid the writing of the log data for the materialized view and the reading of the log data for the next materialized view refresh operation.

### BRIEF DESCRIPTION OF THE DRAWINGS

Advantages of one or more disclosed embodiments may become apparent upon reading the following detailed description and upon reference to the drawings in which:

FIG. 1 is a block diagram illustrating a computer network in accordance with embodiments of the present invention;

FIG. 2 is a block diagram illustrating a refresh operation in accordance with embodiments of the present invention.

FIG. 3 is a block diagram illustrating an exemplary materialized view associated with an exemplary base table that may be implemented in embodiments of the present invention;

FIG. 4 is a block diagram illustrating an exemplary flow of changes from refresh log to update the materialized view that may be implemented in embodiments of the present invention;

FIG. 5 is a block diagram illustrating one or more materialized views associated with a base table that may be implemented in embodiments of the present invention; and

FIG. 6 is a block diagram illustrating an exemplary refresh pipeline flow of changes from one materialized view to another materialized view that may be implemented in embodiments of the present invention.

### DESCRIPTION OF SPECIFIC EMBODIMENTS

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions may be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

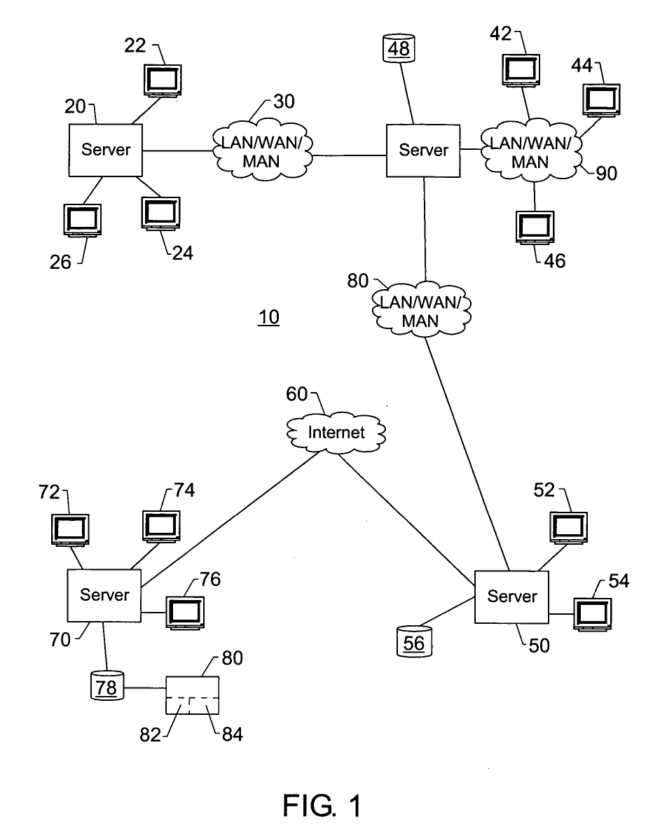

Turning now to the drawings and referring initially to FIG. 1, a block diagram of a computer network architecture is illustrated and designated using a reference numeral 10. A server 20 may be connected to a plurality of client computers 22, 24 and 26. The server 20 may be connected to as many as “n” different client computers. Each client computer in the network 10 may be a functional client computer. The magnitude of “n” may be a function of the computing power or capacity of the server 20. The computing power or capacity of the server 20 may be a function of many design factors such as the number and speed of processors and/or the size of the system memory, for example.

The server 20 may be connected via a network infrastructure 30, which may include any combination of hubs, switches, routers, and the like. While the network infrastructure 30 is illustrated as being either a local area network (“LAN”), storage area network (“SAN”) a wide area network (“WAN”) or a metropolitan area network (“MAN”), those skilled in the art will appreciate that the network infrastructure 30 may assume other forms or may even provide network connectivity through the Internet. As described below, the network 10 may include other servers, which may be dispersed geographically with respect to each other to support client computers in other locations.

The network infrastructure 30 may connect the server 20 to server 40, which may be representative of any other server in the network environment of server 20. The server 40 may be connected to a plurality of client computers 42, 44, and 46. As illustrated in FIG. 1, a network infrastructure 90, which may include a LAN, a WAN, a MAN or other network configuration, may be used to connect the client computers 42, 44 and 46 to the server 40. A storage device 48 such as a hard drive, storage area network (“SAN”), RAID array or the like may be attached to the server 40. The storage device 48 may be used to store a database or portion of a database for use by other network resources. Portions or partitions of a single database may be stored on various different storage devices within the network 10.

The server 40 may be adapted to create log files for updating materialized views that may be stored on the storage device 48. For example, the server 40 may be adapted to identify Insert/Update or Delete (“IUD”) operations made to base tables that affect the materialized view and create a log entry with a timestamp indicating when the operation to the base table occurred.

The server 40 may additionally be connected to server 50, which may be connected to client computers 52 and 54. A network infrastructure 80, which may include a LAN, a WAN, a MAN or other network configuration, which may be used to connect the client computers 52, 54 to the server 50. The number of client computers connected to the servers 40 and 50 may depend on the capacity of the servers 40 and 50 to process information. A storage device 56 such as a hard drive, storage area network (“SAN”), RAID array or the like may be attached to the server 50. The storage device 56 may be used to store a database or portion of a database for use by other network resources.

The server 50 may be adapted to create log files for updating materialized views that may be stored on the storage device 56. For example, the server 50 may be adapted to identify Insert/lUpdate or Delete operations made to base tables that affect the materialized view and create a log entry with a timestamp indicating when the operation to the base table occurred.

The server 50 may additionally be connected to the Internet 60, which may be connected to a server 70. The server 70 may be connected to a plurality of client computers 72, 74 and 76. The server 70 may be connected to as many client computers as its computing power may allow. A storage device 78 such as a hard drive, storage area network (“SAN”), RAID array or the like may be attached to the server 40. The storage device 78 may be used to store a database 80 or portion of a database for use by other network resources. The database 80 may comprise a materialized view 82 (shown in dashed lines) and a base table 84 (shown in dashed lines). Those of ordinary skill in the art will appreciate that other storage devices in the network 10 may store databases, which may include materialized views.

The server 70 may be adapted to create log files for updating materialized views that may be stored on the storage device 78, such as the materialized view 82. For example, the server 70 may be adapted to identify Insert/Update or Delete operations made to base tables, such as base table 84, that affect the materialized view 82 and create a log entry with a timestamp indicating when the operation to the base table occurred.

A database may be accessed through an application program, which may be referred to as a database management system or “DBMS.” The DBMS typically performs database management functions. The DBMS may additionally allow users to add new data to the database or access data already stored in the database for other operations, such as retrieving data, updating data and/or deleting data. An access to the database to retrieve data is typically referred to as a “query.” A query may be performed across an entire relational database and may request data from one or more tables within the database 80. When a query is used multiple times, it may be convenient to create a “view” within the database, which defines that query. This view may appear to the user as another table in the database that contains the results of the query. However, the view is not actually materialized as a table, and when a query is performed against the view, it is translated by the database into an equivalent query against the base tables, which is typically much more complex and time consuming. Alternately, a “materialized view” may be utilized to improve efficiency by storing the query results a table. This prevents the database from having to compute the query results each time the query is performed. However, materialized views need to be “maintained” or “refreshed” as the data in their base tables change over time.

Further, in a networked computing environment, the information stored in a database 80 may not all be in a centralized location. Portions of data in a single relational database may be stored on different servers on different network segments, or even in different cities or countries. To make processing the information faster, a relational database may be partitioned among a number of servers to allow parallel processing of queries. The use of materialized views may also make the processing of queries more efficient.

To maintain the materialized view 82, each base table 84 that has one or more materialized views, automatically maintains a log. The Insert/Update or Delete (“IUD”) operations are logged to a log associated with the base table 84. The log may serve the materialized views associated with the base table 84. As such, when changes take place in the base table 82, the materialized view 82 may be designated to be refreshed according to one of two incremental refresh policies. Those policies may be referred to as a deferred refresh policy and an immediate refresh policy. Immediate refreshing refers to a policy in which materialized views, such as materialized view 82, are updated after every change to an underlying base table 84. In many cases, immediate refreshing is not practical because it adds overhead to operations that change the base table. For a deferred refresh policy, updates are collected in a log and applied periodically. Then, the log of updates may be applied to the materialized view 82, which may vary in duration depending on the number of updates and the size of the base table 84.

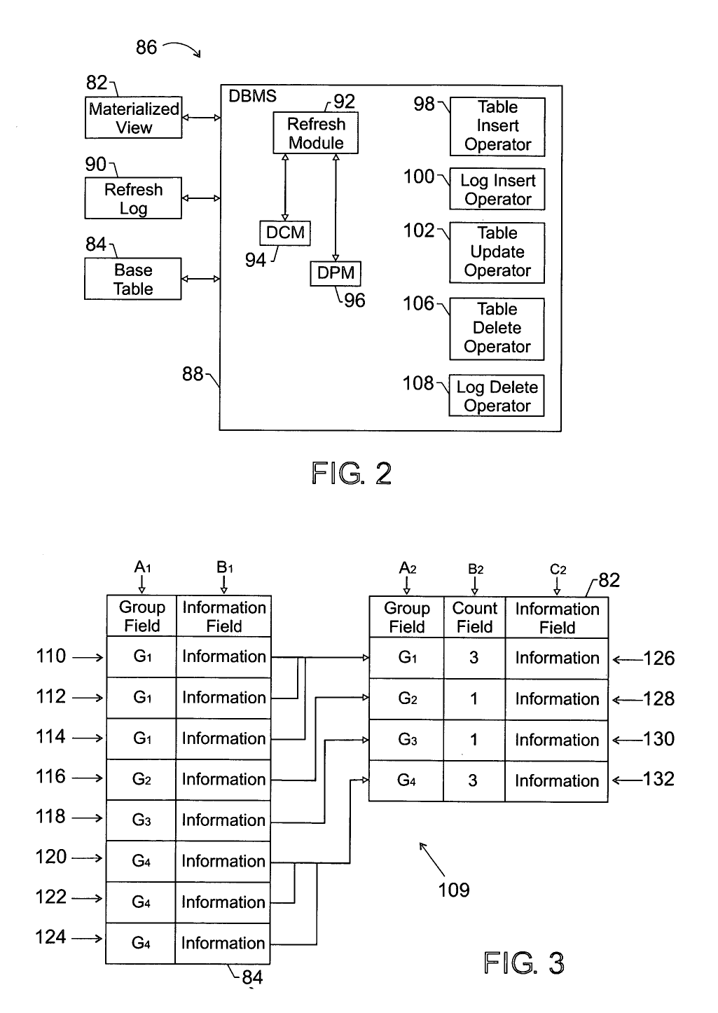

FIG. 2 is a block diagram illustrating a refresh operation in accordance with embodiments of the present invention. The reference numeral 86 refers generally to the elements shown in FIG. 2. The network architecture 10 (FIG. 1) may include a database engine, such as a database management system (“DBMS”) 88, which may be adapted to create refresh log files, such as the refresh log 90, for updating materialized views, such as the materialized view 82. The DBMS 88 may control the database, which may be a structured query language (“SQL”) database. The refresh log 90, the base table 84 and the materialized view 82 may be stored on one or more of the storage devices 48, 56 and/or 78 of the network architecture 10 (FIG. 1). Also, as discussed above, the materialized view 82 is in part derived from a base table 84.

The DBMS 88 may include a refresh module 92 that may automatically perform the functions of maintaining a refresh log 90 and updating the materialized view 82. The refresh module 92 may be a software program, such as a refresh algorithm that may be implemented within the DBMS 88 or a refresh manager that is a combination or hardware and software components. The refresh module 92 may perform refresh operations in a single execution tree or pipeline to avoid input/output overhead of writing to and reading from intermediate log tables.

The refresh module 92 may utilize a delta calculation module (“DCM”) 94 and a delta processing module (“DPM”) 96 to perform the refresh operations. The DCM 94 may be utilized to read data from the refresh log 90, and compute delta values, which include the specific data utilized to update the materialized view 82. The DPM 96 may receive the delta values from the DCM 94. The DPM 96 may verify the operation to be performed and send the row information to appropriate operators, which are discussed below. The operation of the DCM 94 and the DPM 96 will be explained in greater detail below.

The DBMS 88 may include a logging phase that utilizes the operators 98-108 and a refreshing phase that utilizes the refresh module 92 that may be adapted to identify IUD operations made to the base table 84 if those IUD operations affect the materialized view 82. The logging phase may include the creation of log entries in the refresh log 90 that indicate the nature of the modification to the base table 84. The creation of an entry in the refresh log 90 may be performed automatically as a part of an IUD operation on the underlying base table 84. Further, the refresh module 92 may utilize different operators to perform the updates, insertions and deletions to the materialized view 82. For instance, a table insert operator 98 may perform inserts on the base table 84 and/or the materialized view 82. The log insert operator 100 may perform inserts to the refresh log 90. Similarly, a table update operator 102 may perform updates on the base table 84 and/or materialized view 82. Also, a table delete operator 106 may perform deletions from the base table 84 and/or the materialized view 82. The log delete operator 108 may provide deletion information to the refresh log 90 that relates to the deletions form the base table 84. Accordingly, the refresh module 92 may utilize these various operators 98-106 in response to IUD operations that occur on the base table 84.

Because the refresh module 92 is part of the DBMS 88, the refresh module 92 may operate more efficiently. For instance, data transfers out of or into the database 80 may be reduced with the refresh module 92 being within the DBMS 88. This reduces the data movement to and from the database to a refresh application that is outside the database, which may be implemented to refresh the materialized view 82. In addition, application programming interface (“API”) calls and inter-process communication (“IPC”) calls may also be reduced because the refresh module 92 is within the DBMS 88. This further reduces the time consumed in performing a refresh operation.

FIG. 3 is a block diagram illustrating an exemplary materialized view associated with an exemplary base table that may be implemented in embodiments of the present invention. The reference numeral 109 refers generally to the elements shown in FIG. 3. When the materialized view 82 is created, it is derived or associated with at least one base table, such as base table 84. A one-to-many relationship may exist between the rows 110- 124 in the base table 84 and rows 126-132 in the materialized view 82. Each of the rows 126-132 in the materialized view 82 corresponds to a group of one or more rows 110- 124 in the base table 84. Similarly, each of the rows 110-124 in the base table 84 corresponds to one of the rows 126-132 in the materialized view 82. The relationship between the base table 84 and the materialized view 82 is further discussed below.

In the base table 84, different columns or fields A₁ and B₁ may be utilized to differentiate the information 110B₁-124B₁ within the respective rows 110-124. For instance, a grouping field A₁ may associate rows 110-124 in the base table 84 to one of the rows 126-132 in the materialized view 82. Accordingly, each of the rows 110-124 may include grouping identifiers G₁₋₄ that identifies the group for each of the rows 110-124. For each of the rows 110-124 having a specific grouping identifier G₁₋₄, the values in the grouping field A₁ (i.e. the grouping identifiers G₁₋₄) are equal. For instance, rows 110-114 may be associated with the grouping identifier G₁, row 116 may be associated with grouping identifier G₂, row 118 may be associated with grouping identifier G₃, and rows 120-124 may be associated with grouping identifier G₄. As such, the grouping identifiers G₁₋₄ provide identification for rows 110-124 that are part of the same group.

Similarly, the materialized view 82 may include different columns or fields A₂-C₂ that are utilized to associate the rows 126-132 of the materialized view 82 with the rows 110-124 of the base table 84 and differentiate the information 126C₂-132C₂ within the respective rows 126-132. For instance, a grouping field A₂ of the materialized view 82 may associate each of the specific rows 126-132 in the materialized view 82 to a one or more rows 110-124 in the base table 84. This grouping field A₂ may include the group identifiers G₁₋₄ that identifies the specific group for that row 126-132. Because multiple rows 110-124 may be associated with a single row 126-132 in the materialized view 82, a count field B₂ references the number of rows 110-124 in the base table 84 that are associated with the specific group identifier G₁₋₄. For example, the row 126 may have a grouping field A₂ value of “G₁” and have a count field 126B₂ value of “3,” the row 128 may have a grouping field A₂ value of “G₂” and have a count field B₂ value of “1,” the row 130 may have a grouping field A₂ value of “G₃” and have a count field B₂ value of “1,” and row 132 may have a grouping field A₂ value of “G₄” and have a count field B₂ value of “3.” As such, each of the rows 126-132 may utilize the grouping identifiers G₁₋₄ in the grouping field A₂ along with the count field B₂ to associate the rows 126-132 of the materialized view 82 to the rows 110-124 of the base table 84.

Through the associations discussed above, the grouping field A₂ and the count field B₂ may be utilized to update the materialized view 82 with changes to the base table 84 through the use of the refresh log 90. The materialized view 82 may be updated with four possible approaches. First, if new data is added in the base table 84 with none of the rows 126-132 being associated with the group identifier G₁₋₄, then a new row should be inserted with information from the log 90 and associated with that group identifier in the materialized view 82. This operation is an insertion operation. Secondly, if the rows 110-124 have insertions and deletions of data for the same row in the base table 84, no change is made to the rows 126-132 in the materialized view 82. This operation is a self-canceling operation. Thirdly, if the rows 110-124, which have the same group identifier G₁₋₄, are deleted from the base table 84, and the number of deleted rows equals the value in the count field B₂ in the corresponding MV row 126-132, then the rows 126-132, which have the same group identifier G₁₋₄, are deleted from the materialized view 82. This operation is a deletion operation. Finally, if some of the rows 110-124 correspond to a MV rows 126-132 in the materialized view 82, and does not fall into one of the above categories, then the row 126-132 of the materialized view 82 is updated based on the associated values in the refresh log 90 combined with the value in the materialized view 82, which may be in the information field. From these operations, the materialized view 82 may be refreshed to reflect the changes to the base table 84.

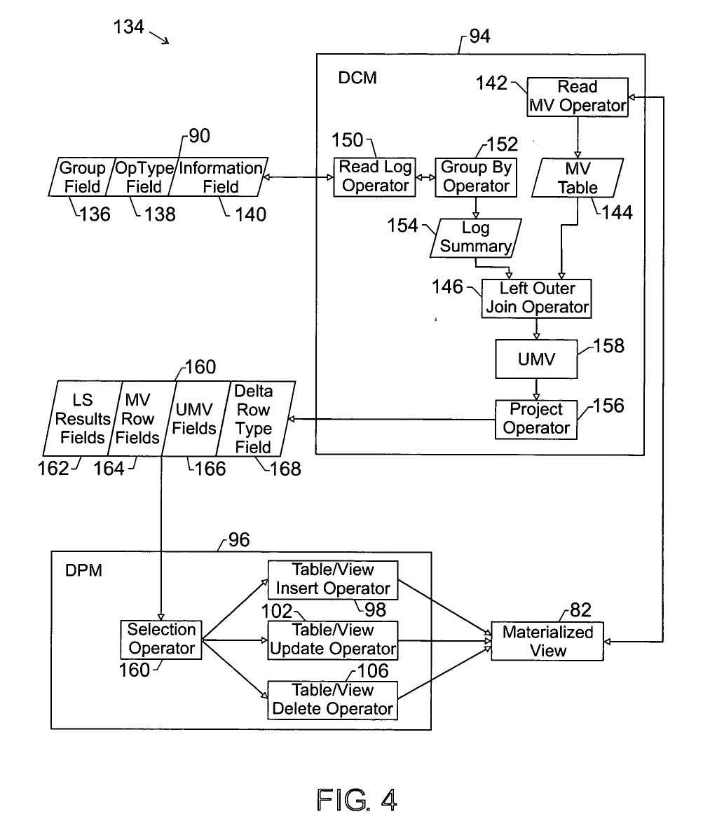

To improve the efficiency of the refreshing operation, the refresh module 92 may utilize the DCM 94 and the DPM 96 to divide the refresh operations. The DCM 94 computes the changes to be applied to the materialized view 82 being refreshed, while the DPM 96 applies the changes to the materialized view 82. Accordingly, once the changes have been computed in the DCM 94, the changes may be used as input data for the next refresh operation. The input data may be utilized for another materialized view when the two materialized views are defined in a specific way, which is discussed below. The flow of changes for a refresh operation is shown in greater detail in FIG. 4.

FIG. 4 is a block diagram illustrating an exemplary flow of changes from the refresh log to update the materialized view that may be implemented in embodiments of the present invention. The reference numeral 134 refers generally to the elements shown in FIG. 4. The refresh operations may be divided into two modules, which may be the DCM 94 and the DPM 96. The DCM 94 computes the changes to be applied to the materialized view 82, while the DPM 96 applies the changes to the materialized view 82.

The refresh log 90 may include various rows and columns that are related to specific rows 126-132 of the materialized view 82 and specific rows 110-124 of the base table 84. The refresh log 90 may include different columns or fields 136-142, such as the grouping field 136 that includes the grouping identifiers, the OpType field 138 that is the type of operation to be performed, and the associated data in the information field 140. However, it should be noted that the information in the OpType field 138 may be derived from other fields, such as the information field 140. For each of the rows of the refresh log 90, the OpType field 138 may have two possible values to identify an insertion or deletion operation that was performed on one of the specific rows 110-124 of the base table 84. For instance, if the value in the OpType field 138 is “1,” then an insertion operation may be indicated. If the value in the OpType field 138 is “−1,” then a deletion operation may be indicated. For an update operation, a deletion operation on one row may be followed by an insertion operation on another row, which reference the same row 110-124 of the base table 84.

The DCM 94 may include various operators, which access the refresh log 90 and the materialized view 82 to calculate the delta values that are to be applied to the materialized view 82. For instance, a read materialized view (“MV”) operator 142 may access the data from rows 126-132 of the materialized view 82. The read MV operator 142 may access the rows 126-132 in the materialized view 82 that are relevant to this refresh operation. Accordingly, the read MV operator 142 may provide the relevant rows 126-132 of the materialized view 82, as a materialized view (“MV”) table 144, to a left outer join operator 146 for further processing, which is discussed below.

Also, other operators in the DCM 94 may access the rows of the refresh log 90. For instance, a read log operator 150 may access the data from the different rows of the refresh log 90, which are relevant to the refresh operation. The read log operator 150 may forward the data collected from the refresh log 90 to the GroupBy operator 152. The GroupBy operator 152 combines the rows of the refresh log 90 based on the grouping identifier in the grouping field 136. Also, the GroupBy operator 152 may perform aggregate functions on the data from the refresh log 90. The aggregate functions computed by the GroupBy operator 152 are a transformation of the aggregate functions used in the materialized view 82, which include the operations indicated by the value in the OpType field 138. Examples of the aggregate function transformations are shown below in TABLE 1. For example, as shown in TABLE 1, the value of the data in the base table 84 may be represented by A, and the value of the Optype field 138 may represent the specific operation performed on the rows 110-124 of the base table 84.

TABLE 1

| Aggregate used in the MV | Transformed aggregate function |
|---|---|
| COUNT(*) | SUM(OpType) |
| COUNT(A) | SUM(IF (A IS NULL) THEN 0 ELSE |
| | OpType) |
| SUM(A) | SUM(A * OpType) |

This transformation performed in the GroupBy operator 152, which combines the operations that are associated with rows in the refresh log 90 based on the grouping identifier. First, data from deleted rows is subtracted while data from inserted rows is added to the calculations. Secondly, the null values are correctly handled to prevent an invalid calculation. As a result, a log summery (“LS”) 154 is created by the GroupBy operator 152, which includes a row for each of the grouping identifiers. The GroupBy operator 152 forwards the LS 154 to a left outer join operator 146 for further processing with the MV table 144.

To provide the delta values 160 to the DPM 96, the left outer join operator 146 and a project operator 156 may be utilized to calculate the changes based on the MV table 144 and the LS 154. The left outer join operator 146 correlates rows of the MV table 144 with the rows of the LS 154 into an updated materialized view (“UMV”) table 158. The rows in the MV table 144 correlate to the rows in the LS 154 in a one-to-one relationship. The project operator 156 calculates the delta values 160 to be supplied to the DPM 96. The delta values 160 may be a table having columns, such as a LS result fields 162 that includes a set of values from the LS 154, a MV row fields 164 that includes a set of values from the row 126-132 of the materialized view 82, a UMV fields 166 that includes a set of values from the updated MV table 158, and a DeltaRowType field 168, which includes values that are associated with an insert, update, delete, and self-cancel operations. The set of values in the LS result fields 162, the MV row fields 164, and the UMV fields 166 may each include the group field A₂, count field B₂, and information field C₂. As a result, for a COUNT and/or SUM aggregate functions, the values in the UMV fields 166 are the sum of the values in the rows of the MV table 144 along with the values in the rows of the LS 154. Further, in the SUM aggregate function, there is an added complication that null values need to be handled correctly, which is shown below in the calculation of the DeltaRowType field 168.

The DeltaRowType field 168 may be calculated based on the values in the LS 154, the MV table 144 and the UMV 158, and represents the operation to be performed to update the corresponding materialized view row, which may be one of four different operations. For instance, when the count field of the MV row fields 164 is null and the count field of the LS result fields 162 is equal to “0,” then the operation is a self-canceling operation. This means that the rows that were inserted to a new group in the base table 84 and were later deleted from the base table 84, which remains unchanged and no operation is needed to update the materialized view 82. If the count field of the MV row field 164 is a null value and the LS result field 164 is equal to some value, an insertion operation is performed. This means that a corresponding row 126-132 was not found in the materialized view 82, which results in a new row being inserted into the materialized view 82 with the information fields of the materialized view 82 being equal to the value in the information field of the LS result fields 162. If the count field of the MV row field 164 is equal to a negative of the LS count field 162, then a deletion operation is performed. This means that all the base table rows 110-124 corresponding to a group identifier were deleted from the base table 84. When none of the preceding conditions apply, the corresponding materialized view row should be updated according to the values of the information field in the UMV fields 166. Once the delta values 160 are calculated, the DCM 94 provides the delta values 160 to the DPM 96, or may provide the delta values to a flow operator (not shown), which is discussed below.

The DPM 96 may check the values in the delta values 160 and send each of the rows in the delta values 160 to a specific operator based upon the value in the DeltaRowType field 168. For instance, a selection operator 169 may access the value in the DeltaRowType field 168 to determine the appropriate operator, which may be the table/view insert operator 98, the table/view update operator 102, and the table/view delete operator 106. As discussed above, the operators 98, 102, and 106 may be utilized to refresh the individual rows 126-132 of the materialized view 82. Accordingly, through the use of the DCM 94 and the DPM 96, the refresh operations may be performed in the more efficiently and without having to transfer data out of the database.

Beneficially, through the use of the DCM 94 and the DPM 96, the refresh operations may be performed in a more efficient manner by dividing the refresh operations into calculation and application modules. This reduces the data movement to and from external applications that are utilized to perform the refresh operations of the materialized view 82. Further, no API or IPC calls are utilized because the DCM 94 and DPM 96 perform the refresh operations within the database. As a result, the performance of the database and the efficiency of the database are improved.

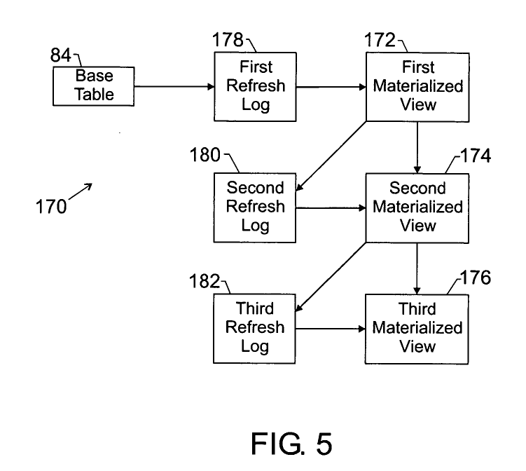

Additionally, it should be noted that when materialized views are defined one on top of another, the materialized views may be refreshed in a pipeline to further improve efficiency by utilizing the DCM 94 and the DPM 96. The refresh pipeline may utilize the DCM 94 and DPM 96 to form a single refresh tree, which avoids the input/output (“I/O”) overhead of writing to and reading from an intermediate log for the materialized views that are derived from a first materialized view. Also, when the single refresh tree is compiled, it can take advantage of the built-in parallelism capabilities of the database. This leverages the robust parallelism capabilities of the database instead of designing a specific solution for a specialized situation. To use parallelism to execute the refresh operation, the refresh operation may be coded into the refresh module 92 to utilize the DCM 94 and the DPM 96 in a pipeline tree. As a result, a refresh pipeline may be formed to minimize input/output writes and reads to log files for refreshing associated materialized views. Accordingly, the refresh operation may also improve the efficiency when multiple materialized views are based on an underlying materialized view or base table, as discussed below in FIG. 5.

In FIG. 5, a block diagram illustrating one or more materialized views associated with a base table that may be implemented in embodiments of the present invention is shown. In this diagram, which is generally referenced by the reference numeral 170, the base table 84 may be associated with a first materialized view 172, a second materialized view 174, a third materialized view 176, a first refresh log 178, a second refresh log 180, and a third refresh log 182. The interrelation of these materialized views 172-176 and refresh logs 178-182 is discussed below in greater detail.

The base table 84 may be associated with multiple materialized views 172-176 and the associated refresh logs 178-182. The first materialized view 172 may be derived from the base table 84, the second materialized view 174 may be derived from the first materialized view 172, and the third materialized view 176 may be derived from the second materialized view 174. The first materialized view 172 may be associated with the first refresh log 178 that includes changes or updates from the base table 84 that are to be applied to the fist materialized view 172. Also, the second materialized view 174 may be associated with the second refresh log 180 that includes changes or updates from the first materialized view 172 that are to be applied to the second materialized view 174. Further, the third materialized view 176 may be associated with the third refresh log 182 that includes changes or updates from the second materialized view 174 that are to be applied to the third materialized view 176. Each of the materialized views 172-176 may be exemplary embodiments of the materialized view 82 (FIG. 2), while the refresh logs 178-182 may be exemplary embodiments of the refresh log 90 (FIG. 2).

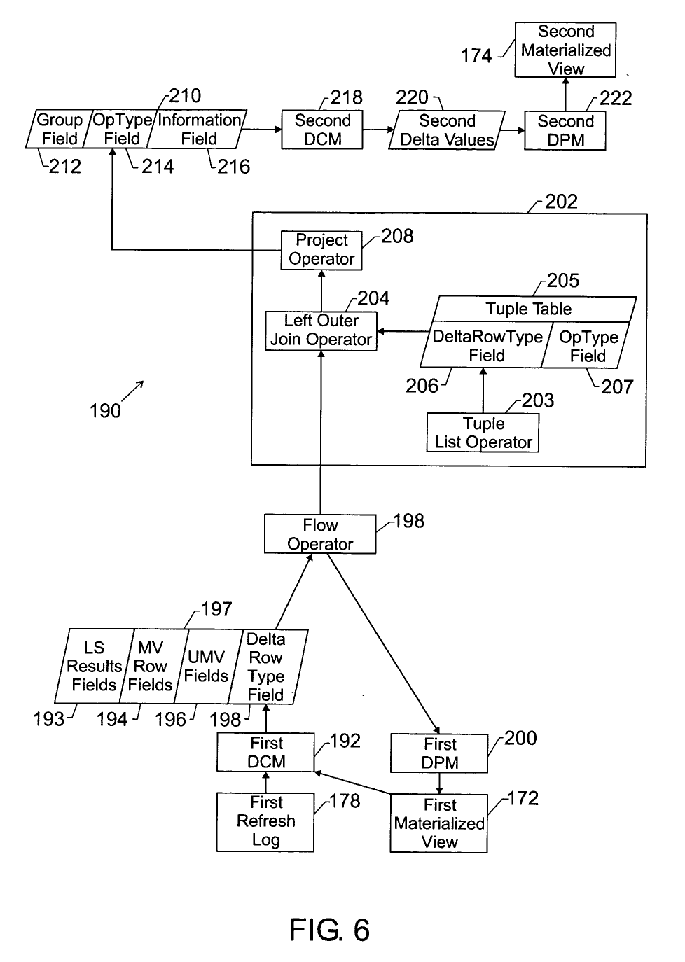

By having the materialized views 174-176 derived from the other materialized views 172 or 174, the calculations performed in the DCM 94 and DPM 96 of the first materialized view 172 may be utilized to improve the refresh operations for the second and third materialized views 174-176. As an example, the base table 84 may be associated with sales data. The first materialized view 172 may be a summary of the daily sales data, the second materialized view 174 may be a summary of the sales data by month, and the third materialized view 176 may be a summary of the sales data by quarter. Accordingly, the monthly sales data in the second materialized view 174 may be defined on top of the daily sales data of the first materialized view instead of based on the sales data in the base table 84. This association of the materialized views 172 and 174 takes advantage of the aggregation calculations performed to maintain the first materialized view 172. Similarly, the quarterly sales data in the third materialized view 176 may be defined on top of the monthly sales data of the second materialized view 174 instead of based on the sales data in the base table 84. This association of the materialized views 174 and 176 takes advantage of the aggregation calculations performed to maintain the second materialized view 174. Accordingly, the calculations from underlying materialized views 172 and 174 may be utilized to refresh the overlying materialized views 174 and 176 without writing and reading the data to the intermediate logs, such as the second refresh log 180 and the third refresh log 182. An exemplary refresh pipeline flow from one materialized view to another is shown in greater detail in FIG. 6.

FIG. 6 is a block diagram illustrating an exemplary refresh pipeline flow of changes from one materialized view to another materialized view that may be implemented in embodiments of the present invention. In this diagram, which is generally referenced by the reference numeral 190, the second materialized view 174 may be updated through the use of data that is provided from a first DCM 192 to update a first materialized view 172. In this manner, the refresh operations of the first and second materialized view 172 and 174 may be pipelined together to form a single refresh tree.

The first materialized view 172 may be refreshed through the use of the first refresh log 178, which may be an embodiment of the refresh log 90. As noted above with regards to the refresh log 90, the first refresh log 178 may include various rows and columns that are related to specific rows of the first materialized view 172. The first refresh log 178 may include various fields, such as the OpType field 138, the grouping identifier in the grouping field 136, and data in the information field 140 (FIG. 4). The first DCM 192 calculates the first delta values 197 from the first refresh log 178 and the first materialized view 172, as discussed above in FIG. 4. Accordingly, the first delta values 197 may include fields, such as the LS result field 193, the Mv row field 194, the UMV field 195, and the DeltaRowType field 196, which may correspond to the fields 162-168 (FIG. 4). The flow operator 198 may provide the first delta values 197 to the first DPM 200 to update the first materialized view 172 and to a delta adaptation module (“DAM”) 202, which is discussed below.

In the DAM 202, the first delta values 197 may be provided to the DAM 202 to modify the first delta values 197 into a form expected by the second DCM 208 from a refresh log, such as the second refresh log 180 (FIG. 6). To modify the first delta values 197, the DAM 202 includes a left outer join operator 204 and a tuple list operator 203. The left outer join operator 204 correlates the rows of the first delta values 197 with the tuple list operator 203. A tuple list operator 203 provides a tuple table 205 with predefined values. The tuple table 205 may include a DeltaRowType field 106 and an Optype field 207. For instance, the tuple list operator 203 is constructed to provide the tuple table 205 with two columns and four rows, as shown below in TABLE 2:

TABLE 2

| DeltaRowType | OpType |
|---|---|
| Field | Field |
| INSERT | 1 |
| DELETE | −1 |
| UPDATE | 1 |
| UPDATE | −1 |

The rows in the first delta values 197 correlate to the rows in the tuple list operator 203 based on the DeltaRowType field 196 and 206. As a result, for each row the left outer join operator 204 joins the first delta values 197 with the tuple list operator 203 based on the value of the DeltaRowType field 196 and 206 for each row. For example, if the DeltaRowType field 196 is an “insert,” then the OpType field 207 of “1” is joined with that row in the first delta value 197. If the DeltaRowType field 196 is a “delete,” then the OpType field 207 of “−1” is joined with that row in the first delta value 197. Finally, if the DeltaRowType field 196 is an “update,” then the two rows are formed with one having an OpType field 207 of “−1” and the other having an OpType field 207 of “−1.” The result of the left outer join operator 204 is a row that contains the fields 193-196 of the first delta values 197 combined with the OpType field 207 of the tuple table 205.

The project operator 208 calculates an update table 210 that is provided to the second DCM 218. The update table 210 may be a table having columns or fields, such as a group field 212 that includes the group identifier, a OpType field 214 that represents a delete or insert operation, and an information field 216 that includes the value from the LS results field 193, the MV row field 194, or the UMV field 195 from the respective rows of the first delta values 197. This means that for each row in the update table 210, the project operator 208 checks the value of DeltaRowType field 196, and projects a value into the information field 216 based upon the value in the DeltaRowType field 196 for each row. For instance, as is shown in TABLE 3, if the value in the DeltaRowType field 196 is “insert,” then the value in the LS results field 193 is projected into the information field 216 and a “1” is projected into the OpType field 214. If the value in the DeltaRowType field 196 is “delete,” then the value in the MV row field 194 is projected into the information field 216 and a “−1” is projected into the OpType field 214.

Further, if the value in the DeltaRowType field 196 is “update,” then the two rows are created in the update table 210. One of the rows has the value of the MV row field 194 projected into the information field 216 and a “−1” projected into the OpType field 214, while the other the row has the value of the UMV field 195 projected into the information field 216 and a “1” projected into the OpType field 214. Accordingly, the update table 210 conforms to the structure of the second refresh log 180. This enables the second DCM 218 to process the fields 212-216, as if they came from the second refresh log 180.

Accordingly, the update table 210 is provided to the second DCM 218. From this the second DCM 218 may calculate the second delta values 220 from the update table 210 and the second materialized view 174, as discussed above in FIG. 4. Accordingly, the second delta values 220 may include fields, such as the LS result field 162, the MV row field 164, the UMV field 166, and the delta row type field 162 (FIG. 4). The second delta values 220 may be provided to the second DPM 222 directly or through a flow operator (not shown). The second DPM 222 may update the second materialized view 174 from the values in the second delta values 220.

Advantageously, the DCMs 192 and 218 and the DPMs 200 and 222 may be combined into a single refresh or a pipelined refresh execution tree. As a result, the refresh operations may avoid the input/output overhead of writing data to the second refresh log and reading data from the second refresh log. This enables the pipeline execution tree to compile a single execution tree that may take advantage of built-in parallelism capabilities of the database. The design leverages the robust parallelism capabilities of the database instead of designing individual or unique executions trees for different materialized views.

It should be noted that the materialized views 82 and 172-176 are exemplary embodiments that utilize the same grouping dimension (time) and do not involve other base tables or materialized views. However, the use of other dimensions may be incorporated into the present embodiments described above. For instance, the materialized views 82 and 172-176 may use aggregation of different dimensions, such as time, location (i.e. store, city, state, country), product group (i.e. product, brand, section, department), or the like. Furthermore, the materialized views 172-176 may involve joins with other base tables, as long as those other base tables have not incurred changes that need to be updated in the materialized views 172-176 discussed above.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

1. A system for performing refresh operations, the system comprising:
a base table having a first plurality of data entries;
a first materialized view that comprises a second plurality of data entries, the second plurality of data entries being associated with the first plurality of data entries in the base table;
a refresh log that contains a plurality of changes in the base table; and
a module adapted to perform a refresh operation on the first materialized view using the second plurality of data entries, the module configured to;
access the refresh log and the first materialized view;
calculate a plurality of delta values from the plurality of changes in the refresh log and the second plurality of data entries in the first materialized view;
apply the plurality of delta values to the second plurality of data entries in the first materialized view; and
provide the plurality of delta values to a delta adaptation module for updating a second materialized view.

2. The system set forth in claim 1, comprising a delta calculation module (“DCM”) and a delta processing module (“DPM”) in the module, wherein the DCM calculates the plurality of delta values and the DPM directs a plurality of operators based upon the plurality of delta values.

3. The system set forth in claim 2, wherein the first plurality of data entries and the second plurality of data entries each include one of a plurality of grouping identifiers that associate each of the first plurality of data entries with the second plurality of data entries.

4. The system for refreshing the table set forth in claim 3, wherein the DCM utilizes the plurality of group identifiers to combine the second plurality of data entries with the plurality of changes.

5. The system set forth in claim 1, wherein the second plurality of data entries each comprises a grouping field and a count field.

6. A system for performing a pipelined refresh, the system comprising:
a first materialized view derived at least partially from a base table;
a refresh log having a plurality of entries, each of the plurality of entries corresponding to a change in the base table,
a second materialized view derived at least partially from the first materialized view;
a refresh module that comprises;
a first delta calculation module that calculates a plurality of delta values that represents the changes to the first materialized view;
a first delta processing module that applies the plurality of delta values to the first materialized view;
a delta adaptation module that receives the plurality of delta values from the first delta calculation module and calculates a plurality of changes to the second materialized view;
a second delta calculation module that obtains the plurality of changes to the second materialized view from the delta adaptation module; and
a second delta processing module that applies the plurality of changes to the second materialized view from the second delta calculation module to the second materialized view.

7. The system set forth in claim 6, wherein the plurality of entries in the refresh log correspond to a plurality of first materialized view entries in the first materialized view through a plurality of grouping identifiers that associate each of the plurality of entries with the plurality of first materialized view entries.

8. The system set forth in claim 6, comprising a plurality of operators utilized by the first delta processing module to modify the first materialized view based upon the plurality of delta values.

9. The system set forth in claim 6, wherein the second delta calculation module is configured to calculate a plurality of second materialized view delta values from the plurality of changes and deliver the plurality of second materialized view delta values to the second delta processing module.

10. The system set forth in claim 9, wherein the second delta processing module is configured to utilize the plurality of second materialized view delta values to apply the plurality of changes to the second materialized view.

11. A system for performing a refresh operation, comprising:
means for deriving a first materialized view from at least one base table;
means for accessing a refresh log and the first materialized view to perform the refresh operation on the first materialized view;
means for calculating a plurality of delta values by combining a plurality of changes in the refresh log and a plurality of entries in the first materialized view;
means for applying the plurality of delta values to the first materialized view; and
means for providing the plurality of delta values to a delta adaptation module for refreshing a second materialized view.

12. A method of performing a refresh operation, the method comprising:
deriving a first materialized view from a base table;
obtaining a refresh log and the first materialized view to perform the refresh operation on the first materialized view;
calculating a plurality of delta values by combining a plurality of changes in the refresh log and a plurality of entries in the first materialized view;
applying the plurality of delta values to the first materialized view; and
providing the plurality of delta values to a delta adaptation module for refreshing a second materialized view derived from the first materialized view.

13. The method set forth in claim 12, wherein obtaining and calculating are performed in a database management system (“DBMS”).

14. The method set forth in claim 12, wherein applying the plurality of delta values comprises utilizing a plurality of operators to modify the first materialized view.

15. The method set forth in claim 12, comprising providing the plurality of delta values to a delta processing module that applies the plurality of delta values to the first materialized view.

16. The method set forth in claim 12, comprising:
processing the plurality of delta values in the delta adaptation module to create a plurality of second materialized view changes for the second materialized view;
calculating a plurality of second materialized view delta values that represent the plurality of second materialized view changes to be applied to the second materialized view; and
applying the plurality of second materialized view changes to the second materialized view.

17. The method set forth in claim 16, comprising combining a tuple table with the plurality of delta values and projecting the plurality of second materialized view changes based upon the tuple table and the plurality of delta values.

18. The method set forth in claim 16, wherein calculating the plurality of second materialized view delta values that represent the plurality of second materialized view changes to be applied to the second materialized view does not involve accessing a refresh log for the second materialized view.

19. The method set forth in claim 12, wherein the method is performed in the recited order.

20. A computer program, comprising:
a machine readable medium;
a refresh log stored on the machine readable medium, the refresh log containing a plurality of change entries; and
a refresh manager stored on the machine readable medium, the refresh manager being adapted to refresh a first materialized view derived at least in part from a base table by computing a plurality of delta values in a delta calculation module based on the refresh log and the first materialized view, applying the plurality of delta values in a delta processing module to the first materialized view, and providing the plurality of delta values to a delta adaptation module derived from the first materialized view.

21. The computer program set forth in claim 20, wherein each of the plurality of change entries comprises a group identifier.

22. The computer program set forth in claim 20, wherein the delta calculation module combines the plurality of change entries and a plurality of entries in the first materialized view to create the plurality of delta values.
